(19) United States
(12) Patent Application Publication
(10) Pub. No.: US 2026/0058556 A1
(43) Pub. Date: Feb. 26, 2026

(54) POWER SUPPLY AND CONTROLLER

(71) Applicant: Chicony Power Technology Co., Ltd., New Taipei City (TW)

(72) Inventors: Ssu-Hao Wang, New Taipei City (TW); Tso-Jen Peng, New Taipei City (TW); You-Cheng Hong, New Taipei City (TW)

(73) Assignee: Chicony Power Technology Co., Ltd., New Taipei City (TW)

(21) Appl. No.: 18/975,413

(22) Filed: Dec. 10, 2024

(30) Foreign Application Priority Data
Aug. 22, 2024 (TW) 113131674

(51) Int. Cl. H02M 3/158; H02M 1/00; H02M 7/217

(52) U.S. Cl. CPC H02M 3/158; H02M 1/0009; H02M 1/007; H02M 7/217

(57) ABSTRACT

A power supply and a controller are provided. The power supply includes an input port, a plurality of output ports, a first conversion circuit, a second conversion circuit, a first switching circuit, a second switching circuit and a control circuit. The input port receives an input voltage. The first conversion circuit converts the input voltage into a first voltage. The second conversion circuit converts the first voltage into a second voltage. When a first output port of these output ports completes a first power supply negotiation with the control circuit, the control circuit controls the first switching circuit to connect the first conversion circuit to the first output port. Before the first power supply negotiation is completed, the first switching circuit disconnects the first conversion circuit from these output ports, and the second conversion circuit does not output the second voltage.

### CROSS-REFERENCE TO RELATED APPLICATION

This non-provisional application claims priority under 35 U.S.C. § 119 (a) to patent application No. 113131674 filed in Taiwan, R.O.C. on Aug. 22, 2024, the entire contents of which are hereby incorporated by reference.

### BACKGROUND

### Technical Field

The disclosure relates to power supplying technology, and in particular to a multi-output power supply and a controller.

### Related Art

With the popularity of electronic products in recent years, most users often need to charge multiple electronic products, including not only low-power electronic products, but also electronic products with high output power, such as tablet computers or notebook computers. Therefore, a power supply needs to have multiple output ports and be able to provide multiple required electric powers at the output ports.

### SUMMARY

In view of this, some embodiments of the disclosure provide a power supply, including an input port, a plurality of output ports, a first conversion circuit, a second conversion circuit, a first switching circuit, a second switching circuit and a control circuit. The input port receives an input voltage. The first conversion circuit is coupled to the input port and converts the input voltage into a first voltage. The second conversion circuit is coupled to the first conversion circuit and converts the first voltage into a second voltage. The first switching circuit is coupled to the first conversion circuit and these output ports. The second switching circuit is coupled to the second conversion circuit and these output ports. The control circuit is coupled to the first conversion circuit, the second conversion circuit, the first switching circuit and the second switching circuit. When a first output port of these output ports completes a first power supply negotiation with the control circuit, the control circuit controls the first switching circuit to connect the first conversion circuit to the first output port. Before the first power supply negotiation is completed, the first switching circuit disconnects the first conversion circuit from these output ports, and the second conversion circuit does not output the second voltage.

Some embodiments of the disclosure provide a power supplying method, applicable to a power supply including a first conversion circuit, a second conversion circuit, a first switching circuit, a second switching circuit and a plurality of output ports. The power supplying method includes: carrying out a first power supply negotiation with a first output port of these output ports; when the first power supply negotiation is completed, controlling the first conversion circuit to output a first voltage, and controlling the first switching circuit to connect the first conversion circuit to the first output port; and before the first power supply negotiation is completed, controlling the first switching circuit to disconnect the first conversion circuit from these output ports, and controlling the second conversion circuit not to output a second voltage.

Some embodiments of the disclosure provide a controller performing the aforementioned power supplying method.

Based on the above, according to the power supply, the power supplying method and the controller provided in some embodiments, the electric power required by the load is transmitted to the corresponding output port through the first switching circuit and the second switching circuit, so that the user can freely couple the load to any output port, which can simplify the circuit design. Besides, the output of the second voltage is blocked by turning off the voltage regulating switch of the second conversion circuit, so that there is no need to provide an additional blocking switch, which can save the material cost for parts. In some embodiments, the currents are monitored according to the equivalent resistances of the switches in the first switching circuit or/and the second switching circuit, so that there is no need to provide an additional current detection unit, which can save the material cost for parts.

### BRIEF DESCRIPTION OF THE DRAWINGS

FIG. 1 is a circuit block diagram of a power supply according to some embodiments;

FIG. 2 is a flowchart (I) of a power supplying method according to some embodiments;

FIG. 3 is a detailed circuit diagram of a second conversion circuit according to some embodiments;

FIG. 4 is a detailed circuit diagram of the power supply according to some embodiments;

FIG. 5 is a circuit diagram of the power supply with a single output of a voltage level according to some embodiments;

FIG. 6 is a circuit diagram of the power supply with a single output of a voltage level according to some embodiments;

FIG. 7 is a flowchart (II) of the power supplying method according to some embodiments;

FIG. 8 is a circuit diagram of the power supply with two outputs of the same voltage level according to some embodiments;

FIG. 9 is a circuit diagram of the power supply with two outputs of different voltage levels according to some embodiments;

FIG. 10 is a circuit diagram of the power supply with two outputs of different voltage levels according to some embodiments; and

FIG. 11 is a detailed circuit diagram of the power supply according to some embodiments.

### DETAILED DESCRIPTION

As used herein, “coupled” means that two or more elements “directly” make physical or electrical contact with each other or “indirectly” make physical or electrical contact with each other, or that two or more elements interact with each other. The terms including “first” and “second” used herein are used to distinguish the referred elements, and are not intended to sort or limit the differences of the referred elements or to limit the scope of the disclosure.

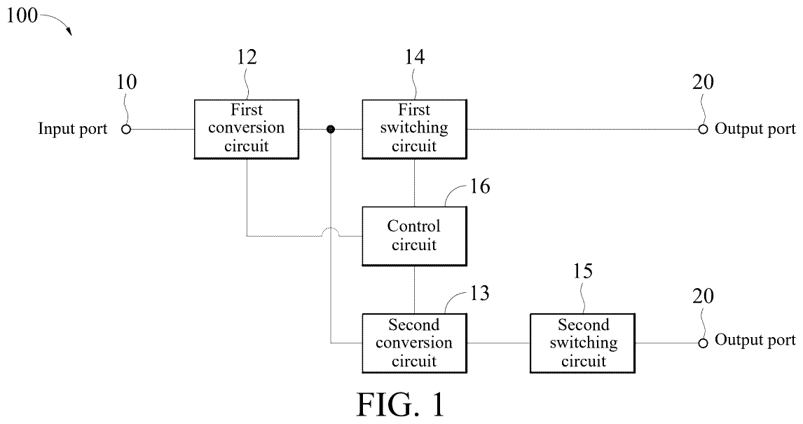

FIG. 1 is a circuit block diagram of a power supply 100 according to some embodiments. The power supply 100 includes an input port 10, a plurality of output ports 20 (two output ports 20 are shown here), a first conversion circuit 12, a second conversion circuit 13, a first switching circuit 14, a second switching circuit 15 and a control circuit 16. The first conversion circuit 12 is coupled to the input port 10. The second conversion circuit 13 is coupled to the first conversion circuit 12. The first switching circuit 14 is coupled to the first conversion circuit 12 and the output ports 20. The control circuit 16 is coupled to the first conversion circuit 12, the second conversion circuit 13, the first switching circuit 14 and the second switching circuit 15, and performs a power supplying method to control these circuits. The power supply 100 receives an input voltage via the input port 10, converts the input voltage into a proper output voltage, and supplies the proper output voltage to a coupled power receiving device (or referred to as a load) via the output port 20.

The first conversion circuit 12 obtains the input voltage via the input port 10 and converts the input voltage into a first voltage. The second conversion circuit 13 obtains the first voltage via the first conversion circuit 12 and converts the first voltage into a second voltage. The first switching circuit 14 is configured to establish or cut off the connection between the first conversion circuit 12 and each output port 20. The second switching circuit 15 is configured to establish or cut off the connections between the second conversion circuit 13 and each output port 20.

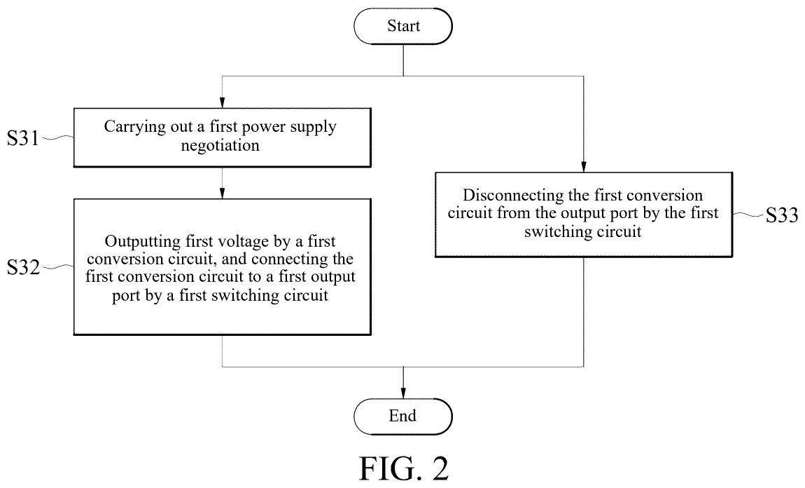

Referring to FIG. 1 and FIG. 2, FIG. 2 is a flowchart (I) of a power supplying method according to some embodiments. In step S31, one of these output ports 20 (hereinafter referred to as a first output port) is coupled to the load so as to carry out a first power supply negotiation with the control circuit 16. In step S32, when the first power supply negotiation is completed, the control circuit 16 controls the first conversion circuit 12 to output the first voltage, and controls the first switching circuit 14 to connect the first conversion circuit 12 to the first output port so as to supply the required electric power to the load. In step S33, before the first power supply negotiation is completed, the control circuit 16 controls the first switching circuit 14 to disconnect the first conversion circuit 12 from these output ports 20 so as to prevent the first voltage from being outputted to any output port 20. The control circuit 16 controls the second conversion circuit 13 not to output the second voltage, such that the second voltage is not outputted to any output port 20, thereby preventing improper electric power from being outputted to the load. Thereby, the load can be freely coupled to any output port 20, and proper electric power can be obtained after the first power supply negotiation is completed.

In some embodiments, the input voltage is an AC power source, the first conversion circuit 12 is an AC-DC converter, and the second conversion circuit 13 is a DC-DC converter.

In some embodiments, the input voltage is a DC power source, the first conversion circuit 12 is a DC-DC converter, and the second conversion circuit 13 is a DC-DC converter.

In some embodiments, the AC-DC converter is, for embodiment, but not limited to, a flyback power converter, and the DC-DC converter is, for embodiment, but not limited to, a BUCK converter.

In some embodiments, the first voltage outputted by the first conversion circuit 12 is greater than the second voltage outputted by the second conversion circuit 13, that is, the second conversion circuit 13 is a BUCK DC converter.

In some embodiments, the control circuit 16 is a controller, for embodiment, but not limited to, a microcontroller, a digital signal processor (DSP), a field-programmable gate array (FPGA) or an application-specific integrated circuit (ASIC) to perform the power supplying method according to some embodiments.

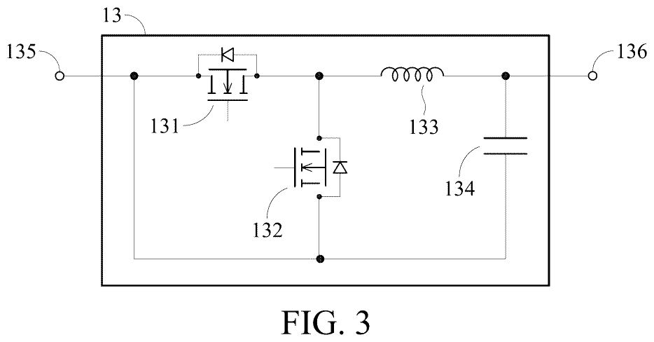

FIG. 3 is a detailed circuit diagram of the second conversion circuit 13 according to some embodiments. Here, the second conversion circuit 13 is described in an embodiment of a BUCK converter. The BUCK converter includes a voltage regulating switch 131, an active rectifying switch 132, an inductor 133 and a capacitor 134. The voltage regulating switch 131 and the active rectifying switch 132 are coupled to the control circuit 16 (not shown), and controlled by the control circuit 16 to be off or on. One end of the voltage regulating switch 131 is coupled to the active rectifying switch 132, and the other end of the voltage regulating switch 131 is coupled to an input terminal 135 (here, receiving the first voltage) of the second conversion circuit 13. Duty cycles of the voltage regulating switch 131 and the active rectifying switch 132 are respectively controlled by the control circuit 16 to make them perform a switching operation (alternately switching between an off state and an on state), such that the voltage regulating switch 131 and the active rectifying switch 132 are alternately turned on. That is, when the voltage regulating switch 131 is on, the active rectifying switch 132 is off; and when the voltage regulating switch 131 is off, the active rectifying switch 132 is on. When the active rectifying switch 132 is off, a body diode thereof prevents the current from flowing reversely. The inductor 133 and the capacitor 134 are coupled to each other. One end of the inductor 133 is coupled between the voltage regulating switch 131 and the active rectifying switch 132. The other end of the inductor 133 is coupled to an output terminal 136 (here, outputting the second voltage) of the second conversion circuit 13. When the voltage regulating switch 131 is on (the active rectifying switch 132 is off), the first voltage is applied to the inductor 133 to accumulate energy. When the voltage regulating switch 131 is off (the active rectifying switch 132 is on), the energy of the inductor 133 is released to the output terminal 136 and the capacitor 134. In this way, the voltage regulation function is realized by controlling the duty cycles, such that the first voltage is regulated to the second voltage. Therefore, the control circuit 16 can allow the second conversion circuit 13 not to output the second voltage by controlling the voltage regulating switch 131 to be kept off, and allow the second conversion circuit 13 to output the second voltage by controlling the voltage regulating switch 131 to perform a switching operation.

In some embodiments, the active rectifying switch 132 in FIG. 3 is replaced by a diode, which prevents the current from flowing reversely when the voltage regulating switch 131 is on, and provides a current path when the voltage regulating switch 131 is off.

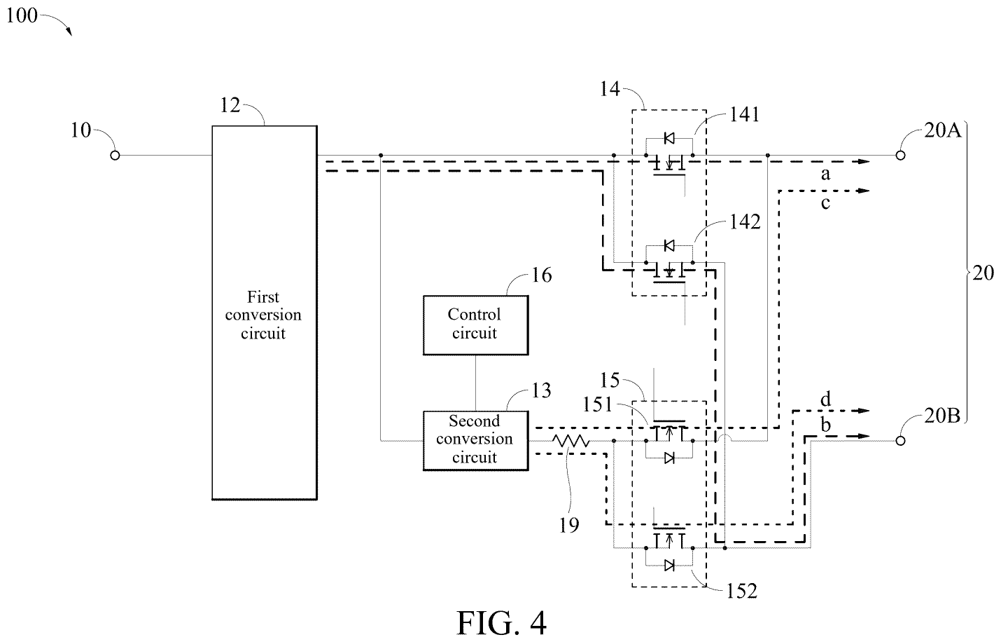

FIG. 4 is a detailed circuit diagram of the power supply 100 according to some embodiments. The first switching circuit 14 includes a first switch 141 and a second switch 142. The first switch 141 and the second switch 142 are coupled to the control circuit 16 (not shown), and controlled by the control circuit 16 to be on or off. For convenience of description, two output ports 20 are defined here as 20A and 20B respectively. The first switch 141 is located on a first path “a” between the first conversion circuit 12 and the output port 20A to determine whether the first conversion circuit 12 is connected to the output port 20A (i.e., whether the first path “a” is connected) in response to the state of the first switch 141. That is, when the first switch 141 is on, the first conversion circuit 12 is connected to the output port 20A (i.e., the first path “a” is connected); and when the first switch 141 is off, the first conversion circuit 12 is disconnected from the output port 20A (i.e., the first path “a” is disconnected). Similarly, the second switch 142 is located on a second path “b” between the first conversion circuit 12 and the output port 20B to determine whether the first conversion circuit 12 is connected to the output port 20B (i.e., whether the second path “b” is connected) in response to the state of the second switch 142. That is, when the second switch 142 is on, the first conversion circuit 12 is connected to the output port 20B (i.e., the second path “b” is connected); and when the second switch 142 is off, the first conversion circuit 12 is disconnected from the output port 20B (i.e., the second path “b” is disconnected).

As shown in FIG. 4, the second switching circuit 15 includes a third switch 151 and a fourth switch 152. The third switch 151 and the fourth switch 152 are coupled to the control circuit 16 (not shown), and controlled by the control circuit 16 to be on or off. The third switch 151 is located on a third path “c” between the second conversion circuit 13 and the output port 20A to determine whether the second conversion circuit 13 is connected to the output port 20A (i.e., whether the third path “c” is connected) in response to the state of the third switch 151. That is, when the third switch 151 is on, the second conversion circuit 13 is connected to the output port 20A (i.e., the third path “c” is connected); and when the third switch 151 is off, the second conversion circuit 13 is disconnected from the output port 20A (i.e., the third path “c” is disconnected). Similarly, the fourth switch 152 is located on a fourth path “d” between the second conversion circuit 13 and the output port 20B to determine whether the second conversion circuit 13 is connected to the output port 20B (i.e., whether the fourth path “d” is connected) in response to the state of the fourth switch 152. That is, when the fourth switch 152 is on, the second conversion circuit 13 is connected to the output port 20B (i.e., the fourth path “d” is connected); and when the fourth switch 152 is off, the second conversion circuit 13 is disconnected from the output port 20B (i.e., the fourth path “d” is disconnected).

In some embodiments, the first switch 141 to the fourth switch 152, the voltage regulating switch 131 and the active rectifying switch 132 aforementioned are metal-oxide-semiconductor field effect transistors (MOSFETs).

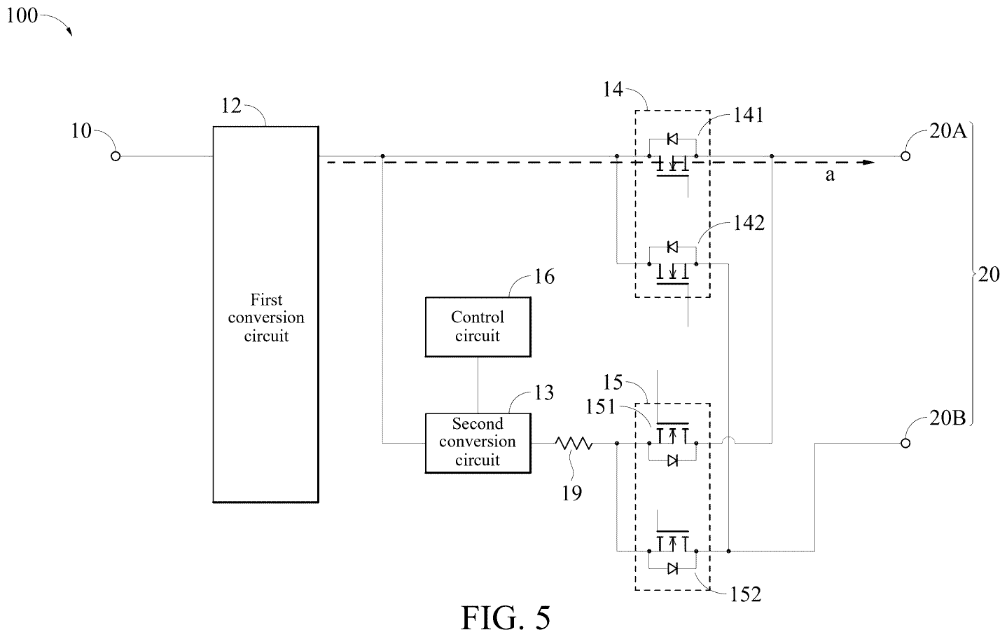

Next, the switching operation of the power supply path will be described. Referring to FIG. 4 and Table 1, Table 1 illustrates the operation of Embodiment I. In Embodiment I, the output port 20A is the aforementioned first output port, that is, the output port 20A is coupled to the load and the output port 20B is not coupled to the load. “Before the first power supply negotiation is completed” (including the period when no load is coupled; and the period when a load is coupled and the first power supply negotiation has not been completed), the first switch 141 to the fourth switch 152, the voltage regulating switch 131 and the active rectifying switch 132 are all off. “When the first power supply negotiation is completed”, the first switch 141 is turned on, such that the first conversion circuit 12 outputs the first voltage to the output port 20A through the first path “a” (as shown in FIG. 5).

TABLE 1

| | Before the first power | When the first power |
|---|---|---|
| | supply negotiation is | supply negotiation is |
| Embodiment I | completed | completed |
| First switch 141 | Off | On |
| Second switch 142 | Off | Off |
| Third switch 151 | Off | Off |
| Fourth switch 152 | Off | Off |
| Voltage regulating | Off | Off |
| switch 131 | | |
| Active rectifying | Off | Off |
| switch 132 | | |

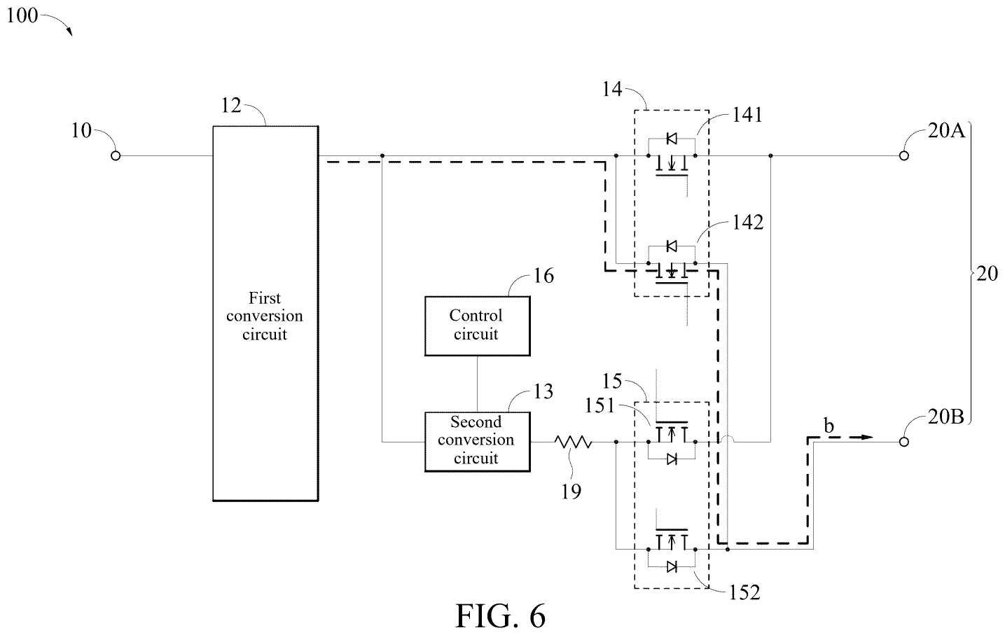

Referring to FIG. 4 and Table 2, Table 2 illustrates the operation of Embodiment II. In Embodiment II, the output port 20B is the aforementioned first output port, that is, the output port 20B is coupled to the load and the output port 20A is not coupled to the load. “Before the first power supply negotiation is completed”, as in the aforementioned Embodiment I, the first switch 141 to the fourth switch 152, the voltage regulating switch 131 and the active rectifying switch 132 are all off. “When the first power supply negotiation is completed”, the second switch 142 is turned on, such that the first conversion circuit 12 outputs the first voltage to the output port 20B through the second path “b” (as shown in FIG. 6).

TABLE 2

| | Before the first power | When the first power |
|---|---|---|
| | supply negotiation is | supply negotiation is |
| Embodiment II | completed | completed |
| First switch 141 | Off | Off |
| Second switch 142 | Off | On |
| Third switch 151 | Off | Off |
| Fourth switch 152 | Off | Off |
| Voltage regulating | Off | Off |
| switch 131 | | |
| Active rectifying | Off | Off |
| switch 132 | | |

For convenience of description, the coupled load in the aforementioned Embodiment I and Embodiment II is defined here as the first load. In Embodiment III to Embodiment VIII described later, in addition to the first output port coupled to the first load, another output port 20 (hereinafter referred to as the second output port) is further coupled to a second load. The second output port is coupled to the second load so as to carry out a second power supply negotiation with the control circuit 16.

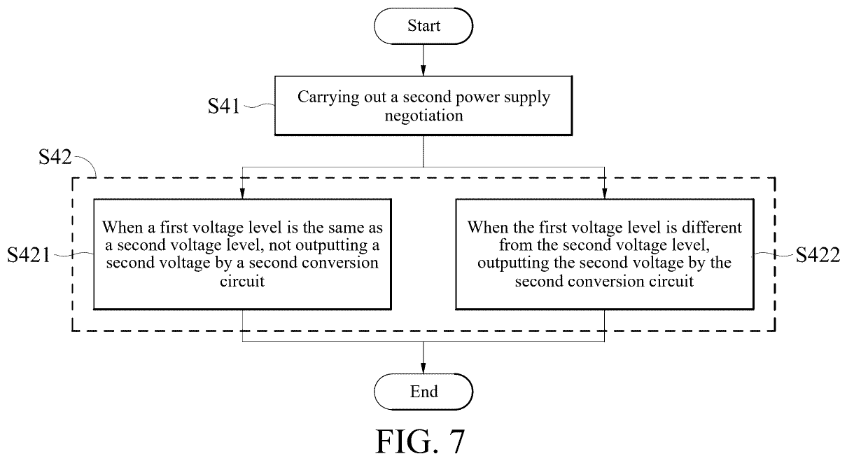

FIG. 7 is a flowchart (II) of the power supplying method according to some embodiments. In step S41, the second output port carries out a second power supply negotiation with the control circuit 16. In step S42, the control circuit 16 controls the second conversion circuit 13 to output or not to output the second voltage according to a comparison result between a first voltage level and a second voltage level. The first voltage level corresponds to the first power supply negotiation, and is determined in the first power supply negotiation. The second voltage level corresponds to the second power supply negotiation, and is determined in the second power supply negotiation. Specifically, when the first voltage level is the same as the second voltage level, the control circuit 16 controls the second conversion circuit 13 not to output the second voltage (step S421); and when the first voltage level is different from the second voltage level, the control circuit 16 controls the second conversion circuit 13 to output the second voltage (step S422). Embodiment III to Embodiment VIII will be described later. Embodiment III and Embodiment IV describe the case where the first voltage level is the same as the second voltage level, and Embodiment V to Embodiment VIII describe the case where the first voltage level is different from the second voltage level. The first voltage level is the same as the second voltage level means that the voltage values of the two voltage levels are substantially the same while allowing for an acceptable degree of error. On the contrary, the first voltage level is different from the second voltage level means that the voltage values of the two voltage levels are still substantially different even allowing for the error.

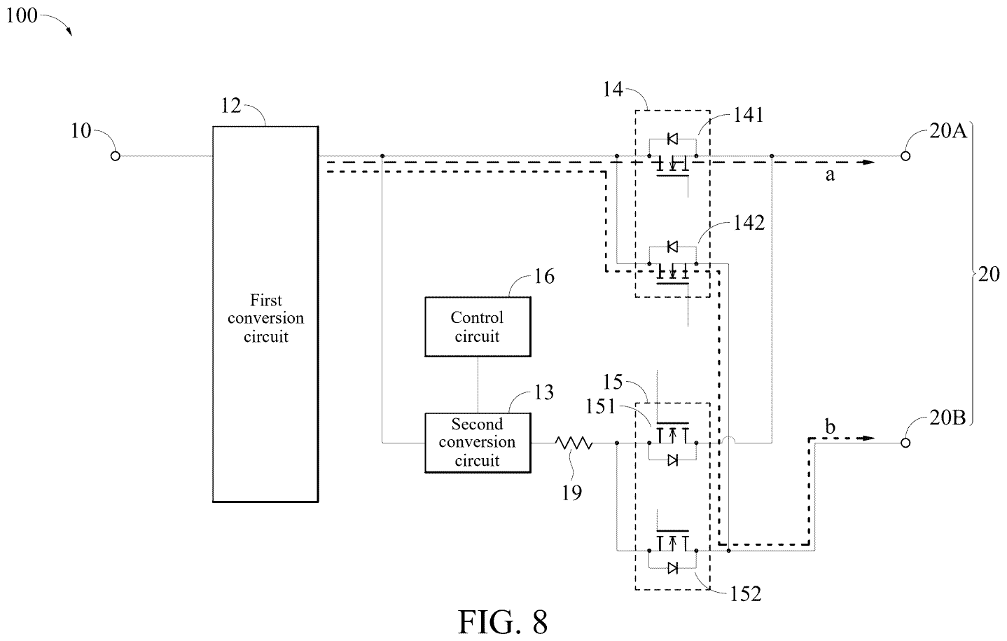

Referring to FIG. 4 and Table 3, Table 3 illustrates the operation of Embodiment III. Embodiment III is based on the aforementioned Embodiment I (the output port 20A is coupled to the first load), and further, the output port 20B is coupled to the second load and the voltage levels required by the two loads are the same. Therefore, the on/off state “before the second power supply negotiation is completed” in Table 3 is the same as the on/off state “when the first power supply negotiation is completed” in Table 1. When the second power supply negotiation is completed, according to the aforementioned step S421, the second conversion circuit 13 still does not output the second voltage. Therefore, the third switch 151, the fourth switch 152, the voltage regulating switch 131 and the active rectifying switch 132 are still kept off (as shown in FIG. 8) so as to prevent the second voltage from being outputted to the output port 20A or/and the output port 20B. In order to make the second output port obtain corresponding electric power, the control circuit 16 controls the first switching circuit 14 to connect the first conversion circuit 12 to the second output port. In Embodiment III, the second output port refers to the output port 20B. The second switch 142 is turned on, so that the first conversion circuit 12 outputs the first voltage first voltage to the output port 20B through the second path “b”.

TABLE 3

| | Before the second power | When the second power |
|---|---|---|
| | supply negotiation is | supply negotiation is |
| Embodiment III | completed | completed |
| First switch 141 | On | On |
| Second switch 142 | Off | On |
| Third switch 151 | Off | Off |
| Fourth switch 152 | Off | Off |
| Voltage regulating | Off | Off |
| switch 131 | | |
| Active rectifying | Off | Off |
| switch 132 | | |

Referring to FIG. 6 and Table 4, Table 4 illustrates the operation of Embodiment IV. Embodiment IV is based on the aforementioned Embodiment II (the output port 20B is coupled to the first load), and further, the output port 20A is coupled to the second load and the voltage levels required by the two loads are the same. Therefore, the on/off state “before the second power supply negotiation is completed” in Table 4 is the same as the on/off state “when the first power supply negotiation is completed” in Table 2. When the second power supply negotiation is completed, according to the aforementioned step S421, the control circuit 16 controls the first switching circuit 14 to connect the first conversion circuit 12 to the second output port. In Embodiment IV, the second output port refers to the output port 20A. When the first switch 141 is turned on, the first conversion circuit 12 outputs the first voltage to the output port 20A through the first path “a”. In summary, in Embodiment III and Embodiment IV, when the second power supply negotiation is completed, the first switch 141 and the second switch 142 are both on, and the third switch 151, the fourth switch 152, the voltage regulating switch 131 and the active rectifying switch 132 are all off (as shown in FIG. 8). In this case, the first conversion circuit 12 outputs the first voltage to the two output ports 20 through the first path “a” and the second path “b”.

TABLE 4

| | Before the second power | When the second power |
|---|---|---|
| | supply negotiation is | supply negotiation is |
| Embodiment IV | completed | completed |
| First switch 141 | Off | On |
| Second switch 142 | On | On |
| Third switch 151 | Off | Off |
| Fourth switch 152 | Off | Off |
| Voltage regulating | Off | Off |
| switch 131 | | |
| Active rectifying | Off | Off |
| switch 132 | | |

Referring to FIG. 4 and Table 5, Table 5 illustrates the operation of Embodiment V and Embodiment VI. Embodiment V is based on Embodiment I (the output port 20A is coupled to the first load), and further, the output port 20B is coupled to the second load. Embodiment VI is based on Embodiment II (the output port 20B is coupled to the first load), and further, the output port 20A is coupled to the second load. In Embodiment V and Embodiment VI, the first voltage level (the voltage level required by the first load) is greater than the second voltage level (the voltage level required by the second load). Table 5 illustrates the on/off state “when the second power supply negotiation is completed” in Embodiment V and Embodiment VI. For the on/off state “before the second power supply negotiation is completed” in Embodiment V, reference may be made to Table 3, and for the on/off state “before the second power supply negotiation is completed” in Embodiment VI, reference may be made to Table 4, which will not be repeated here. In Embodiment V and Embodiment VI, when the second power supply negotiation is completed, according to the aforementioned step S422, the second conversion circuit 13 outputs the second voltage to the second output port (the first voltage is still outputted to the first output port). Therefore, the second switching circuit 15 connects the second conversion circuit 13 to the second output port.

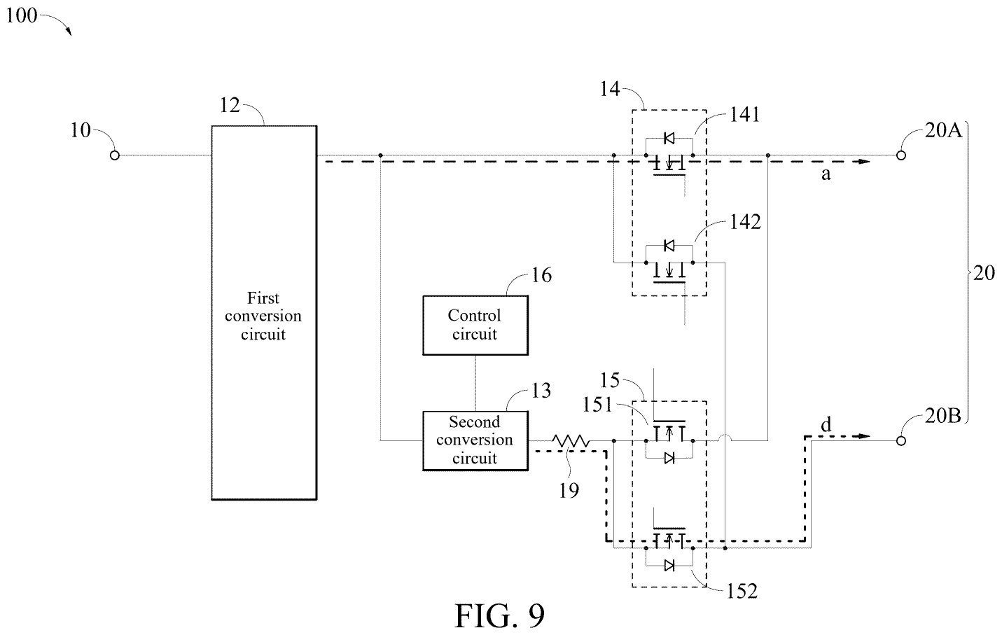

In Embodiment V, when the second power supply negotiation is completed, as shown in FIG. 9, the first switch 141 is kept on and the second switch 142 is kept off, so that the first conversion circuit 12 outputs the first voltage to the output port 20A through the first path “a”. On the other hand, the third switch 151 is off and the fourth switch 152 is on, so that the second conversion circuit 13 outputs the second voltage to the output port 20B through the fourth path “d”.

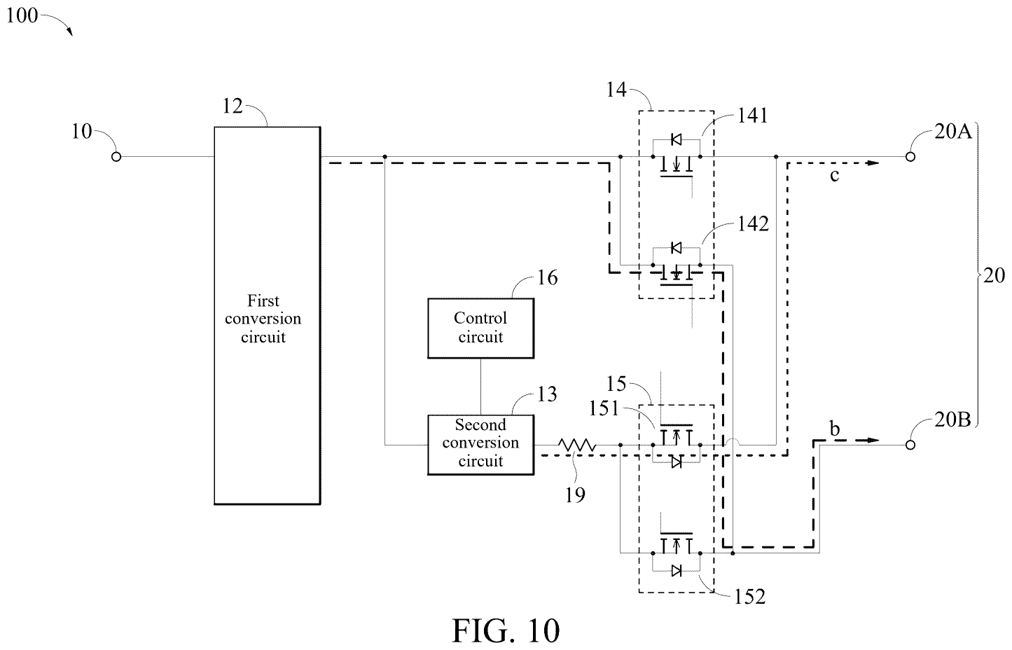

In Embodiment VI, when the second power supply negotiation is completed, as shown in FIG. 10, the first switch 141 is kept off and the second switch 142 is kept on, so that the first conversion circuit 12 outputs the first voltage to the output port 20B through the second path “b”. On the other hand, the third switch 151 is on and the fourth switch 152 is off, so that the second conversion circuit 13 outputs the second voltage to the output port 20A through the third path “c”.

In addition, in Embodiment V and Embodiment VI, the voltage regulating switch 131 and the active rectifying switch 132 perform a switching operation, such that the voltage regulating switch 131 and the active rectifying switch 132 are alternately turned on, and thereby, the second conversion circuit 13 outputs the second voltage.

TABLE 5

| | Embodiment V | Embodiment VI |
|---|---|---|
| | When the second power | When the second power |
| | supply negotiation is | supply negotiation is |
| | completed | completed |
| First switch 141 | On | Off |
| Second switch 142 | Off | On |
| Third switch 151 | Off | On |
| Fourth switch 152 | On | Off |
| Voltage regulating | Switching operation | Switching operation |
| switch 131 | | |
| Active rectifying | Switching operation | Switching operation |
| switch 132 | | |

Referring to FIG. 4 and Table 6, Table 6 illustrates the operation of Embodiment VII and Embodiment VIII. Embodiment VII is based on Embodiment I (the output port 20A is coupled to the first load), and further, the output port 20B is coupled to the second load. Embodiment VIII is based on Embodiment II (the output port 20B is coupled to the first load), and further, the output port 20A is coupled to the second load. In Embodiment VII and Embodiment VIII, the first voltage level (the voltage level required by the first load) is less than the second voltage level (the voltage level required by the second load). Table 6 illustrates the on/off state “when the second power supply negotiation is completed” in Embodiment VII and Embodiment VIII. For the on/off state “before the second power supply negotiation is completed” in Embodiment VII, reference may be made to Table 3, and for the on/off state “before the second power supply negotiation is completed” in Embodiment VIII, reference may be made to Table 4, which will not be repeated here. In Embodiment VII and Embodiment VIII, when the second power supply negotiation is completed, according to the aforementioned step S422, the second conversion circuit 13 outputs the second voltage. However, since the voltage level required by the second load is higher than the voltage level required by the first load, the first voltage is supplied to the second output port, and the second voltage is supplied to the first output port. Thereby, the control circuit 16 controls the first switching circuit 14 to disconnect the first conversion circuit 12 from the first output port and connect the first conversion circuit 12 to the second output port, and controls the second switching circuit 15 to disconnect the second conversion circuit 13 from the second output port and connect the second conversion circuit 13 to the first output port.

In Embodiment VII, when the second power supply negotiation is completed, as shown in FIG. 10, the first switch 141 is kept off and the second switch 142 is kept on, so that the first conversion circuit 12 outputs the first voltage to the output port 20B through the second path “b”. On the other hand, the third switch 151 is on and the fourth switch 152 is off, so that the second conversion circuit 13 outputs the second voltage to the output port 20A through the third path “c”.

In Embodiment VIII, when the second power supply negotiation is completed, as shown in FIG. 9, the first switch 141 is kept on and the second switch 142 is kept off, so that the first conversion circuit 12 outputs the first voltage to the output port 20A through the first path “a”. On the other hand, the third switch 151 is off and the fourth switch 152 is on, so that the second conversion circuit 13 outputs the second voltage to the output port 20B through the fourth path “d”.

In addition, in Embodiment VII and Embodiment VIII, the voltage regulating switch 131 and the active rectifying switch 132 perform a switching operation, such that the voltage regulating switch 131 and the active rectifying switch 132 are alternately turned on, and thereby, the second conversion circuit 13 outputs the second voltage.

TABLE 6

| | Embodiment VII | Embodiment VIII |
|---|---|---|
| | When the second power | When the second power |
| | supply negotiation is | supply negotiation is |
| | completed | completed |
| First switch 141 | Off | On |
| Second switch 142 | On | Off |
| Third switch 151 | On | Off |
| Fourth switch 152 | Off | On |
| Voltage regulating | Switching operation | Switching operation |
| switch 131 | | |
| Active rectifying | Switching operation | Switching operation |
| switch 132 | | |

In summary, in Embodiment V and Embodiment VIII, the voltage level of the output port 20A is greater than the voltage level of the output port 20B, and when the second power supply negotiation is completed, the on/off states in these two embodiments are the same (as shown in FIG. 9). In Embodiment VI and Embodiment VII, the voltage level of the output port 20B is greater than the voltage level of the output port 20A, and when the second power supply negotiation is completed, the on/off states in these two embodiments are the same (as shown in FIG. 10).

It is worth mentioning that in some embodiments, the third switch 151 and the fourth switch 152 respectively have a body diode, and a cathode of the body diode faces the coupled output port 20, so as to prevent the current at the high-voltage terminal from flowing reversely to the low-voltage terminal when the voltage of an output port 20 is higher than the voltage of another output port 20. For embodiment, when the voltage of the output port 20A is higher than the voltage of the output port 20B, the body diode of the third switch 151 can prevent the reverse current on the third path “c”. Similarly, when the voltage of the output port 20B is higher than the voltage of the output port 20A, the body diode of the fourth switch 152 can prevent the reverse current on the fourth path “d”.

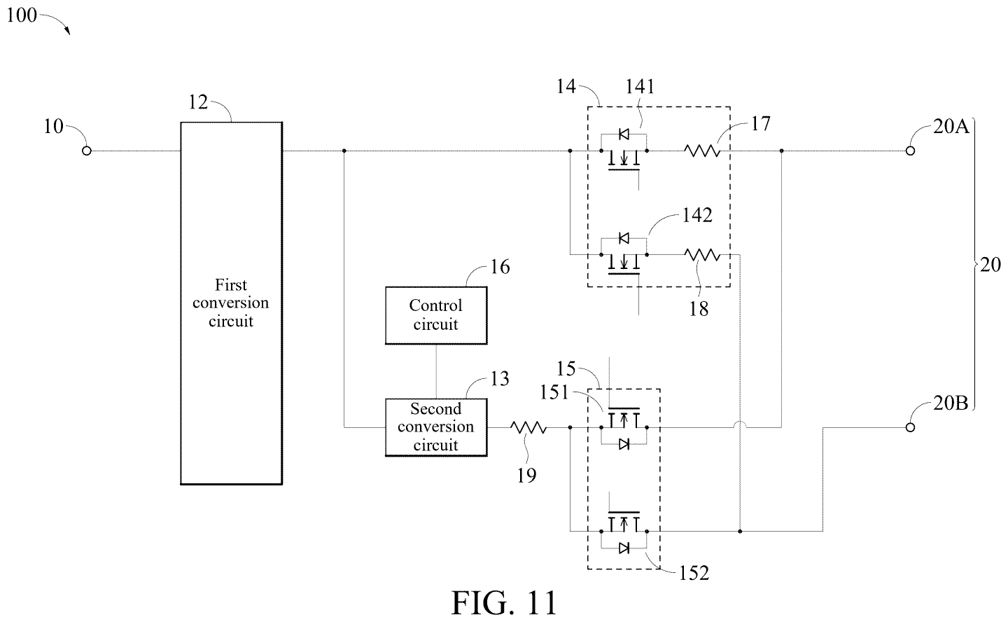

FIG. 11 is a detailed circuit diagram of the power supply 100 according to some embodiments, which illustrates another embodiment of the first switching circuit 14. In some embodiments, the first switching circuit 14 further includes a first current detection unit 17 and a second current detection unit 18. The first current detection unit 17 is arranged on the first path “a” and connected with the first switch 141 in series. The second current detection unit 18 is arranged on the second path “b” and connected with the second switch 142 in series. The first current detection unit 17 and the second current detection unit 18 are, for embodiment, but not limited to, resistors. The control circuit 16 is coupled to the first current detection unit 17 and the second current detection unit 18 to monitor the currents (voltage/resistance) on the first path “a” and the second path “b” according to the voltage across the first current detection unit 17 and the voltage across the second current detection unit 18. Thereby, when it is detected that the current on the first path “a” or/and the second path “b” exceeds the safety threshold, the control circuit 16 may perform an overcurrent protection operation, for embodiment, stopping the running of the first conversion circuit 12 or/and the second conversion circuit 13.

In some embodiments, as shown in FIG. 4, the first switching circuit 14 does not include the first current detection unit 17 and the second current detection unit 18, and the currents are detected according to equivalent resistances of the first switch 141 and the second switch 142. That is, the control circuit 16 monitors the current of the first path “a” according to the equivalent resistance of the first switch 141 when the first switch 141 is on, and monitors the current of the second path “b” according to the equivalent resistance of the second switch 142 when the second switch 142 is on.

In some embodiments, as shown in FIG. 4, the power supply 100 further includes a third current detection unit 19 arranged between the second conversion circuit 13 and the second switching circuit 15. The control circuit 16 monitors the current on the third path “c” or the fourth path “d” according to the voltage across the third current detection unit 19 (according to the descriptions of the aforementioned Embodiment V to Embodiment VIII, only one of the third path “c” and the fourth path “d” is on at one time). Thereby, when it is detected that the current exceeds the safety threshold, the control circuit 16 may perform the overcurrent protection operation, for embodiment, stopping the running of the first conversion circuit 12 or/and the second conversion circuit 13.

In some embodiments, the power supply 100 may not have the third current detection unit 19, and the currents are detected according to equivalent resistances of the third switch 151 and the fourth switch 152. That is, the control circuit 16 monitors the current of the third path “c” according to the equivalent resistance of the third switch 151 when the third switch 151 is on, and monitors the current of the fourth path “d” according to the equivalent resistance of the fourth switch 152 when the fourth switch 152 is on.

In some embodiments, the first power supply negotiation and the second power supply negotiation aforementioned conform to a power delivery protocol, and the output voltage, the maximum output power and other power supply parameters are determined in the first power supply negotiation and the second power supply negotiation.

In some embodiments, at least one of the first switch 141, the second switch 142, the third switch 151 and the fourth switch 152 is integrated with the control circuit 16 in an integrated circuit.

Based on the above, according to the power supply 100, the power supplying method and the controller provided in some embodiments, the electric power required by the load is transmitted to the corresponding output port 20 through the first switching circuit 14 and the second switching circuit 15, so that the user can freely couple the load to any output port 20, which can simplify the circuit design. Besides, the output of the second voltage is blocked by turning off the voltage regulating switch 131 of the second conversion circuit 13, so that there is no need to provide an additional blocking switch, which can save the material cost for parts. In some embodiments, the currents are monitored according to the equivalent resistances of the first switch 141, the second switch 142, the third switch 151 or/and the fourth switch 152, so that there is no need to provide an additional current detection unit, which can save the material cost for parts.

What is claimed is:

1. A power supply, comprising:
an input port, receiving an input voltage;
a plurality of output ports;
a first conversion circuit, coupled to the input port and converting the input voltage into a first voltage;
a second conversion circuit, coupled to the first conversion circuit and converting the first voltage into a second voltage;
a first switching circuit, coupled to the first conversion circuit and the output ports;
a second switching circuit, coupled to the second conversion circuit and the output ports; and
a control circuit, coupled to the first conversion circuit, the second conversion circuit, the first switching circuit and the second switching circuit, when a first output port of the output ports completes a first power supply negotiation with the control circuit, the control circuit controlling the first switching circuit to connect the first conversion circuit to the first output port,
wherein before the first power supply negotiation is completed, the first switching circuit disconnects the first conversion circuit from the output ports, and the second conversion circuit does not output the second voltage.

2. The power supply according to claim 1, wherein when a second output port of the output ports completes a second power supply negotiation with the control circuit, the control circuit controls the second conversion circuit to output or not to output the second voltage according to a comparison result between a first voltage level corresponding to the first power supply negotiation and a second voltage level corresponding to the second power supply negotiation.

3. The power supply according to claim 2, wherein when the first voltage level is the same as the second voltage level, the second conversion circuit does not output the second voltage.

4. The power supply according to claim 2, wherein when the first voltage level is different from the second voltage level, the second conversion circuit outputs the second voltage.

5. The power supply according to claim 4, wherein when the first voltage level is greater than the second voltage level, the second switching circuit connects the second conversion circuit to the second output port.

6. The power supply according to claim 4, wherein when the first voltage level is less than the second voltage level, the control circuit controls the first switching circuit to disconnect the first conversion circuit from the first output port and connect the first conversion circuit to the second output port, and controls the second switching circuit to disconnect the second conversion circuit from the second output port and connect the second conversion circuit to the first output port.

7. The power supply according to claim 4, wherein the first voltage is greater than the second voltage.

8. The power supply according to claim 2, wherein the second conversion circuit comprises a voltage regulating switch coupled to a conversion path between the first conversion circuit and the second switching circuit, the voltage regulating switch being kept off such that the second conversion circuit does not output the second voltage, and the voltage regulating switch performing a switching operation such that the second conversion circuit outputs the second voltage.

9. The power supply according to claim 1, wherein the first switching circuit comprises a first switch and a second switch, the first switch being located on a first path between the first conversion circuit and one of the output ports, and the second switch being located on a second path between the first conversion circuit and another of the output ports.

10. The power supply according to claim 9, wherein the control circuit monitors a current of the first path according to an equivalent resistance of the first switch when the first switch is on, and monitors a current of the second path according to an equivalent resistance of the second switch when the second switch is on.

11. The power supply according to claim 9, wherein the first switching circuit comprises a first current detection unit and a second current detection unit, the first current detection unit being located on the first path, the second current detection unit being located on the second path, and the control circuit monitoring a current of the first path according to the first current detection unit and monitoring a current of the second path according to the second current detection unit.

12. The power supply according to claim 9, wherein the second switching circuit comprises a third switch and a fourth switch, the third switch being located on a third path between the second conversion circuit and the output port coupled to the first path, and the fourth switch being located on a fourth path between the second conversion circuit and the output port coupled to the second path.

13. The power supply according to claim 12, wherein the third switch and the fourth switch respectively have a body diode, and a cathode of the body diode of the third switch and the fourth switch faces the coupled output port.

14. The power supply according to claim 12, further comprising a third current detection unit coupled between the second conversion circuit and the second switching circuit, the control circuit monitoring a current of the third path or the fourth path according to the third current detection unit.

15. The power supply according to claim 12, wherein the control circuit monitors a current of the third path according to an equivalent resistance of the third switch when the third switch is on, and monitors a current of the fourth path according to an equivalent resistance of the fourth switch when the fourth switch is on.

16. A controller, applicable to a power supply comprising a first conversion circuit, a second conversion circuit, a first switching circuit, a second switching circuit and a plurality of output ports, wherein the controller performs a power supplying method comprising:
carrying out a first power supply negotiation with a first output port of the output ports;
when the first power supply negotiation is completed, controlling the first conversion circuit to output a first voltage, and controlling the first switching circuit to connect the first conversion circuit to the first output port; and
before the first power supply negotiation is completed, controlling the first switching circuit to disconnect the first conversion circuit from the output ports, and controlling the second conversion circuit not to output a second voltage.

17. The controller according to claim 16, wherein the power supplying method further comprises:
carrying out a second power supply negotiation with a second output port of the output ports; and
controlling the second conversion circuit to output or not to output the second voltage according to a comparison result between a first voltage level corresponding to the first power supply negotiation and a second voltage level corresponding to the second power supply negotiation.

18. The controller according to claim 17, wherein when the first voltage level is greater than the second voltage level, the second switching circuit is controlled to connect the second conversion circuit to the second output port.

19. The controller according to claim 17, wherein when the first voltage level is less than the second voltage level, the first switching circuit is controlled to disconnect the first conversion circuit from the first output port and connect the first conversion circuit to the second output port, and the second switching circuit is controlled to disconnect the second conversion circuit from the second output port and connect the second conversion circuit to the first output port.

20. The controller according to claim 17, wherein the second conversion circuit comprises a voltage regulating switch coupled to a conversion path between the first conversion circuit and the second switching circuit, and the power supplying method further comprises:
controlling the voltage regulating switch to be kept off such that the second conversion circuit does not output the second voltage; and
controlling the voltage regulating switch to perform a switching operation such that the second conversion circuit outputs the second voltage.

21. The controller according to claim 17, wherein the first switching circuit comprises a first switch and a second switch, the first switch being located on a first path between the first conversion circuit and the first output port, and the second switch being located on a second path between the first conversion circuit and the second output port, and the power supplying method further comprises:
monitoring a current of the first path according to an equivalent resistance of the first switch when the first switch is on; and
monitoring a current of the second path according to an equivalent resistance of the second switch when the second switch is on.

22. The controller according to claim 17, wherein the first switching circuit comprises a first switch and a second switch, the first switch being located on a first path between the first conversion circuit and the first output port, and the second switch being located on a second path between the first conversion circuit and the second output port, the first switching circuit further comprises a first current detection unit located on the first path and a second current detection unit located on the second path, and the power supplying method further comprises:
monitoring a current of the first path according to the first current detection unit; and
monitoring a current of the second path according to the second current detection unit.

23. The controller according to claim 17, wherein the second switching circuit comprises a third switch and a fourth switch, the third switch being located on a third path between the second conversion circuit and the first output port, and the fourth switch being located on a fourth path between the second conversion circuit and the second output port, the power supply further comprises a third current detection unit coupled between the second conversion circuit and the second switching circuit, and the power supplying method further comprises:
monitoring a current of the third path or the fourth path according to the third current detection unit.

24. The controller according to claim 17, wherein the second switching circuit comprises a third switch and a fourth switch, the third switch being located on a third path between the second conversion circuit and the first output port, and the fourth switch being located on a fourth path between the second conversion circuit and the second output port, and the power supplying method further comprises:
monitoring a current of the third path according to an equivalent resistance of the third switch when the third switch is on; and
monitoring a current of the fourth path according to an equivalent resistance of the fourth switch when the fourth switch is on.
